(19) United States
(12) Patent Application Publication
(10) Pub. No.: US 2013/0341948 A1
(43) Pub. Date: Dec. 26, 2013

(54) TRUCK LOAD SUPPORT

(71) Applicants: Gene Folk, Pickerington, OH (US); Pamela Folk, Pickerington, OH (US)

(72) Inventors: Gene Folk, Pickerington, OH (US); Pamela Folk, Pickerington, OH (US)

(21) Appl. No.: 13/528,660

(22) Filed: Jun. 20, 2012

(51) Int. Cl. B60P 3/42

(52) U.S. Cl. 296/10

(57) ABSTRACT

The present invention is a truck load support attached to a pick-up truck with a pick-up truck bed that includes a first channel bar that includes a pair of Z-bracket assemblies with a first horizontal portion and a second horizontal portion, disposed on first channel bar that is attached to the front portion of the pick-up truck bed, the Z-bracket assemblies include a nut, a Z-bracket and a bolt. The truck load support also includes a second channel bar that includes a pair of Z-bracket assemblies with a first horizontal portion and a second horizontal portion, disposed on second channel bar that is attached to the back portion of the pick-up truck bed, the Z-bracket assemblies include a nut, a Z-bracket and a bolt.

### TECHNICAL FIELD & BACKGROUND

Currently there lacks an accessory piece that can allow small or full size pick-up trucks to perform like larger automobiles. Drivers find it challenging to haul amassed supplies due to the vehicles inability to withstand relatively high weight as well as the dimensions of varied materials.

The present invention generally relates to a truck support. More specifically, the invention is a truck load support.

It is an object of the invention to provide a truck load support that allows a user to load and transport one or more relatively large sheet materials onto a variety of pick-up truck sizes.

It is an object of the invention to provide a truck load support that is relatively more versatile than a similar or traditional truck load support.

It is an object of the invention to provide a truck load support that is relatively more portable than a similar or traditional truck load support.

What is really needed is a truck load support that allows a user to load and transport one or more relatively large sheet materials onto a variety of pick-up truck sizes that is relatively more versatile than a similar or traditional truck load support that is relatively more portable than a similar or traditional truck load support.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an environmental top view of a truck load support, according to an embodiment of the present invention.

FIG. 1B illustrates a top view of a first channel bar of a truck load support, according to an embodiment of the present invention.

FIG. 1C illustrates a side view of a second channel bar of a truck load support, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

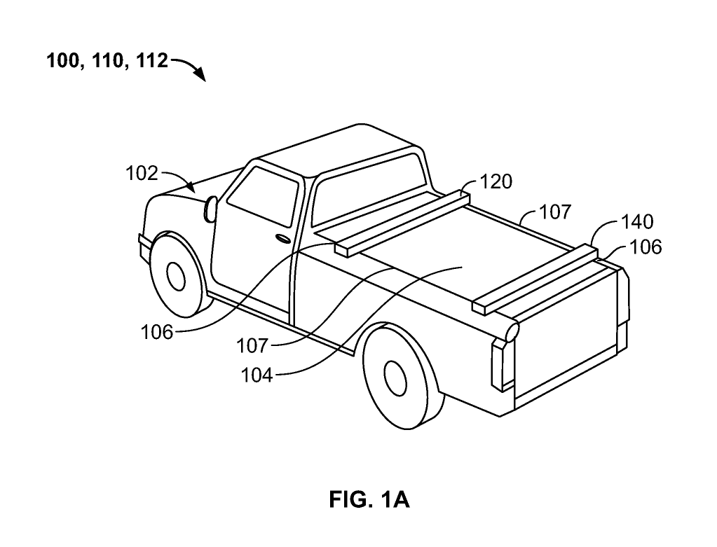

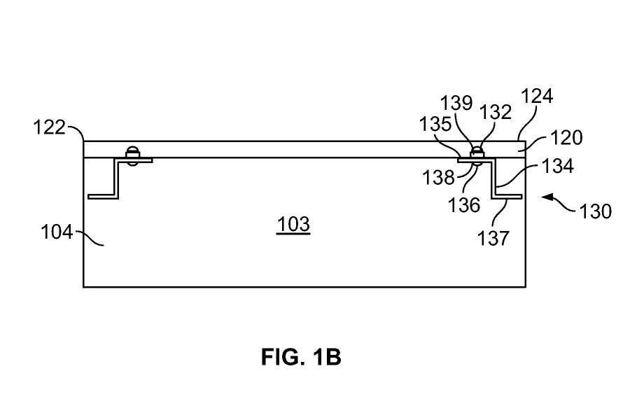

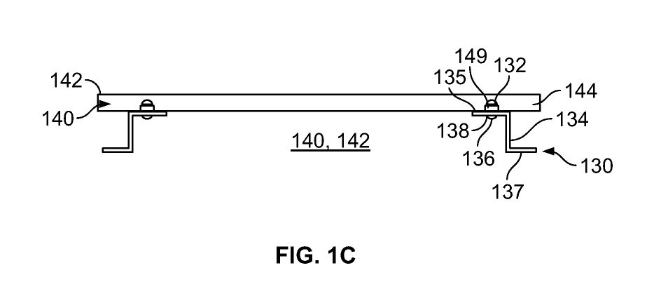

FIG. 1A illustrates an environmental top view of a truck load support 100, according to an embodiment of the present invention. The truck load support 100 illustrated in FIG. 1 A is attached to a pick-up truck 102 and more specifically is attached across a pick-up truck bed 104 with a lip 106 on each side 107 of the pick-up truck bed 104.

The truck load support 100 includes a plurality of channel bars 110. FIG. 1A illustrates the channel bars 110 as including a pair of channel bars 112, although any suitable number of channel bars can be utilized such as 3 channel bars, 4 channel bars or 5 channel bars. The pair of channel bars 112 includes a first channel bar 120 and a second channel bar 140. Additional details regarding the first channel bar 120 is illustrated and described in FIG. 1B and its description. Additional details regarding the second channel bar 140 is illustrated and described in FIG. 1C and its description.

FIG. 1B illustrates a top view of a first channel bar 120 of a truck load support 100, according to an embodiment of the present invention. The first channel bar 120 of the truck load support 100 is similar to the first channel bar 120 described and illustrated in FIG. 1A and its description.

The first channel bar 120 includes a pair of Z-bracket assemblies 130. The first channel bar 120 includes a first end 122 and a second end 124. The first channel bar 120 is removably attached across a front portion 103 of a pick-up truck bed 104. The first channel bar 120 is approximately 6 feet in length, approximately 1-⅝ the of an inch square and weighs approximately 9.5 pounds. The pair of Z-bracket assemblies 130 is disposed below and inside of the first end 122 and the second end 124 of the first channel bar 120 and attach the first end 122 and the second end 124 of the first channel bar 120 to the pick-up truck bed 104. Each of the Z-bracket assemblies 130 includes a nut 132, a Z-bracket 134 and a bolt 136. The nut 132 receives the bolt 136 that is invertedly inserted through a first aperture 138 disposed on a first horizontal portion 135 of the Z-bracket 134. The bolt 136 then extends through the nut 132 and into a second aperture 139 disposed underneath the first channel bar 120. The second aperture 139 is slightly smaller than the bolt 136 to provide a relatively strong attachment of the Z-bracket assemblies 130 to the first channel bar 120. A second horizontal portion 137 of the Z-bracket 134 is then removably inserted under a lip 106 on each side 107 (FIG. 1A) of the pick-up truck bed 104. The first end 122 and the second end 124 of the first channel bar 120 then attachably rest on each side 107 of the pick-up truck bed 104.

FIG. 1C illustrates a side view of a second channel bar 140 of a truck load support 100, according to an embodiment of the present invention. The second channel bar 140 of the truck load support 100 is similar to the second channel bar 140 described and illustrated in FIG. 1A and its description.

The second channel bar 140 has similar components to the first channel bar 120 illustrated and described in FIG. 1B and its description. The second channel bar 140 in contrast to the first channel bar 120 is attached to a back portion 141 of the pick-up truck bed 104.

The second channel bar 140 includes a pair of Z-bracket assemblies 130. The second channel bar 140 includes a first end 142 and a second end 144. The second channel bar 140 is removably attached across a back portion 142 of a pick-up truck bed 104. The second channel bar 140 is approximately 6 feet in length, approximately 1-⅝ of an inch square and weighs approximately 9.5 pounds. The pair of Z-bracket assemblies 130 is disposed below and inside of the first end 142 and the second end 144 of the second channel bar 140 and attach the first end 142 and the second end 144 of the second channel bar 140 to the pick-up truck bed 104. Each of the Z-bracket assemblies 130 includes a nut 132, a Z-bracket 134 and a bolt 136. The nut 132 receives the bolt 136 that is invertedly inserted through a first aperture 138 disposed on a first horizontal portion 135 of the Z-bracket 134. The bolt 136 then extends through the nut 132 and into a third aperture 149 disposed underneath the second channel bar 140. The third aperture 149 is slightly smaller than the bolt 136 to provide a relatively strong attachment of the Z-bracket assemblies 130 to the second channel bar 140. A second horizontal portion 137 of the Z-bracket 134 is then removably inserted under a lip 106 on each side 107 of the pick-up truck bed 104. The first end 142 and the second end 144 of the first channel bar 140 then attachably rest on each side 107 of the pick-up truck bed 104.

The truck load support is a relatively sturdy multi-linked apparatus that supports transit of bulkier items. The truck load support includes two opposing approximate 72 inch channel bars with connecting Z-bracket assemblies, with a measured distance of approximately 1 foot. The truck load support converts a truck bed by adding supportive beams, which are stabilized by utilization of a plurality of bolts and nuts, thereby, providing a bed rail. Positioned under the lips of the truck bed, the truck load support serves as a foundation for safe and secure transport of varied items, ranging from basic tools and supplies to sheets of plywood or lumber and one or more box springs and/or mattresses. The truck load support may be readily available at automotive supply retailers. The truck load support is designed to improve upon the functionality and capabilities of a pick-up truck to give vehicle operators the ability to diversify their transporting options. The feature of an attachable railed truck bed may afford users with a practical method for moving longer and wider materials with relative ease.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A truck load support attached to a pick-up truck, said pick-up truck has a pick-up truck bed, comprising:
a front channel bar that includes a front first end and a front second end and is configured to be positioned across the pick-up truck bed such both that said first front end and said second front end extend outwardly beyond the edges of the pick-up truck bed, wherein said front channel bar includes a pair of front Z-bracket assemblies each having a first front horizontal portion with a first front aperture and a second front horizontal portion, said pair of front Z-bracket assemblies being disposed in a mirror image orientation with one below and inside of said first front end and the other disposed below and inside said second front end, said pair of front Z-bracket assemblies attach said first front end and said second front end to said pick-up truck bed such that no portion of said front channel bar extends outwardly beyond said first front end and said second front end, said front Z-bracket assemblies each include a nut, a Z-bracket and a bolt; and
a back channel bar that includes a back first end and a back second end and is configured to be positioned across the pick-up truck bed such both that said back first end and said back second end extend outwardly beyond the edges of the pick-up truck bed, wherein said back channel bar includes a pair of back Z-bracket assemblies each having a first back horizontal portion with a first back aperture and a second back horizontal portion, said pair of back Z-bracket assemblies being disposed in a mirror image orientation with one below and inside of said first back end and the other disposed below and inside said second back end, said pair of back Z-bracket assemblies attach said first back end and said second back end to said pick-up truck bed such that no portion of said back channel bar extends outwardly beyond said first back end and said second back end, said back Z-bracket assemblies each include a nut, a Z bracket and a bolt.

2. The truck load support according to claim 1, wherein said front channel bar is removably attached in a fixed location across a front portion of said pick-up truck bed.

3-8. (canceled)

8. The truck load support according to claim 1, wherein said second front horizontal portions are removably inserted under a lip on opposing sides of said pick-up truck bed.

9-10. (canceled)

11. The truck load support according to claim 1, wherein said back channel bar is removably attached in a fixed location across a back portion of said pick-up truck bed.

12-17. (canceled)

18. The truck load support according to claim 1, wherein said second back horizontal portions are removably inserted under a lip on opposing sides of said pick-up truck bed.

19-20. (canceled)
